(19) United States
(12) Patent Application Publication
(10) Pub. No.: US 2001/0012440 A1
(43) Pub. Date: Aug. 9, 2001

(54) Data decoding recording apparatus

(75) Inventor: Satoshi Itoi, Tokyo (JP)

Correspondence Address: LAFF, WHITESEL, CONTE & SARET, 401 North Michigan Avenue, Chicago, IL, 60611, US

(73) Assignee: NEC Corporation

(21) Appl. No.: 09/772,767

(22) Filed: Jan. 30, 2001

(30) Foreign Application Priority Data
Feb. 7, 2000 (JP) 2000-029535

(51) Int. Cl. H04N 5/92

(52) U.S. Cl. 386/94; 360/60

(57) ABSTRACT

A data decoding recording apparatus is disclosed which facilitates, when contents of a received digital broadcast are recorded in accordance with a copy control code, editing and preservation of the recorded contents. A digital broadcasting radio wave is subject to demodulation, Viterbi decoding and error correction processing with the Reed-Solomon code by a tuner section and is outputted as a transport stream. A general control section receives the transport stream, extracts a copy control code from the received transport stream and analyzes the copy control code. When the copy control code is “00”, the general control section controls a hard disk drive to record the contents through a digital interface section. When the copy control code is “10”, the general control section either controls one of an optical disk drive and a video tape recorder to record or controls both of the optical disk drive and the video tape recorder or all of the hard disk drive, the optical disk drive and the video tape recorder to record the contents.

### BACKGROUND OF THE INVENTION

1. Field of the Invention

The present invention relates to a data decoding recording apparatus which receives and decodes a digital broadcast and records contents of the decoded digital broadcast.

2. Description of the Related Art

In Japan, BS (broadcasting satellite) digital broadcasting was put into practical use at the end of A.D. 2000. In order to receive a BS digital broadcast, it is necessary to set up an apparatus called set top box (STB) in which a tuner for receiving a broadcasting radio wave, a decoder for decoding the received data and other necessary apparatus are integrated as a unitary member and connect the set top box to a television receiver.

Contents broadcast by a BS digital broadcast have a copy control code added thereto. The copy control code is used to control copying (duplication) of the contents and indicates in what manner the broadcast contents can be recorded by a user. The copy control code is usually composed of 2 bits. When the copy control code is “00”, it represents that copying is free and the contents can be copied unconditionally; when it is “10”, it represents that the contents can be copied only once; when it is “01”, it represents that copying is inhibited by the undertaker; and when it is “11”, it represents that copying is inhibited.

Contents can be recorded by various recording apparatus including a hard disk drive, an optical disk drive and a video tape recorder (VTR). Any of such recording apparatus is built in or connected externally to a set top box.

When a user intends to record contents of a BS digital broadcast, it selects a recording apparatus. The set top box extracts the copy control code from the received BS digital broadcast and analyses it. If a result of the analysis reveals that copying is permitted, then the set top box allows the recording apparatus to record the contents of the BS digital broadcast. However, if the analysis result reveals that copying is inhibited, then the set top box does not allow the recording apparatus to record the contents of the BS digital broadcast but displays such a message as “The contents cannot be copied”.

As described above, when it is tried to record contents of a BS digital broadcast, a user selects a recording apparatus, and the set top box or the selected recording apparatus executes a recording operation in accordance with the copy control code of the BS digital broadcast.

When the copy control code is “00”, there is no special problem because contents of the BS digital broadcast can be copied freely. On the other hand, when the copy control code is “01” or “11”, there is no complicated problem because recording of contents of the BS digital broadcast is inhibited.

However, when the copy control code is “10”, since it indicates the condition that copying is permitted only once, if only a hard disk drive is selected as a recording apparatus for copying the contents of the BS digital broadcast, then the contents recorded on the hard disk drive cannot be copied onto another recording apparatus to preserve or edit them. Particularly since the hard disk drive includes a built-in disk as a recording medium which cannot be removed or exchanged therefrom, it is difficult to preserve the contents copied on the hard disk drive. Therefore, the hard disk drive has a problem in that the application thereof is limited to time shift enjoyment.

Meanwhile, recording of all contents of a BS digital broadcast onto all recording apparatus such as a hard disk drive, an optical disk drive and a video tape recorder has a problem in that much power dissipation is involved.

### SUMMARY OF THE INVENTION

It is an object of the present invention to provide a data decoding recording apparatus which facilitates editing and preservation of contents whose copying is permitted only once by a copy control code used to control copying processing of contents of a digital broadcast.

In order to achieve the object described above, according to the present invention, there is provided a data decoding recording apparatus capable of receiving and decoding a digital broadcast and recording contents of data of the received digital broadcast by a plurality of recording apparatus for different recording media in response to a copy control code included in the received data, comprising control means for extracting and analyzing the copy control code from the received data and selecting and controlling one or those of the recording apparatus which should execute a recording operation regarding the received data in response to a result of the analysis of the copy control code.

Where recording apparatus include a hard disk drive and an optical disk apparatus, when the copy control code represents a copy-free condition, the control means may control the hard disk drive to record the contents, but when the copy control code represents permission of copying only once, the control means may either control the optical disk drive to record the contents or control both of the hard disk drive and the optical disk apparatus to record the contents.

Where the recording apparatus include a hard disk drive and a video tape recorder, when the copy control code represents a copy-free condition, the control means may control the hard disk drive to record the contents, but when the copy control code represents permission of copying only once, the control means may either control the video tape recorder to record the contents or control both of the hard disk drive and the video tape recorder to record the contents.

Where the recording apparatus include an optical disk apparatus and a video tape recorder, when the copy control code represents a copy-free condition, the control means may control the video tape recorder to record the contents, but when the copy control code represents permission of copying only once, the control means may either control the optical disk apparatus to record the contents or control both of the optical disk apparatus and the video tape recorder to record the contents.

Where the recording apparatus include a hard disk drive, an optical disk apparatus and a video tape recorder, when the copy control code represents a copy-free condition, the control means may control the hard disk drive to record the contents, but when the copy control code represents permission of copying only once, the control means may either control one of the optical disk apparatus and the video tape recorder or both of the optical disk apparatus and the video tape recorder to record the contents or control all of the hard disk drive, the optical disk apparatus and the video tape recorder to record the contents.

When the copy control code represents permission of copying only once, the control means may delete any unnecessary portion included in the contents in accordance with a rule determined in advance and control any of the recording apparatus to copy the remaining portion of the contents.

The control means may control any of the recording apparatus to record contents whose copy control code represents permission of copying only once and which are considered not to include a commercial message portion but control any of the recording apparatus to record contents whose copy control code represents a copy-free condition and which are considered to include a commercial message portion.

When the copy control code represents permission of copying only once, the control means may secure two or more sound streams as sound data recording areas for the contents in advance and record the received sound data into the sound data recording area for one of the sound streams but fill the remaining one or more streams with a particular stuffing bit so that sound data may be additionally recorded into the stream or streams filled with the stuffing bits.

Preferably, when the copy control code represents permission of copying only once, the control means inhibits recording into a partially erased area of a recording medium of any of the recording apparatus and causes data to be recorded continuously to the last end of the recorded data without fail.

With the data decoding recording apparatus, different recording processing from that for contents whose copy control code is “00” and which can therefore be copied freely is performed for contents whose copy control code is “10” and which can therefore be copied only once. Consequently, recording and preservation of contents which can be copied only once are facilitated.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a block diagram showing a data decoding recording apparatus to which the present invention is applied;

FIG. 2 is a diagrammatic view illustrating recording of data with an unnecessary portion deleted;

FIG. 3 is a diagrammatic view illustrating an example of image and sound data recorded on a recording medium; and

FIG. 4 is a diagrammatic view illustrating recording of data whose copy control code is “10” onto an optical disk having partially erased areas.

### DESCRIPTION OF THE PREFERRED EMBODIMENT

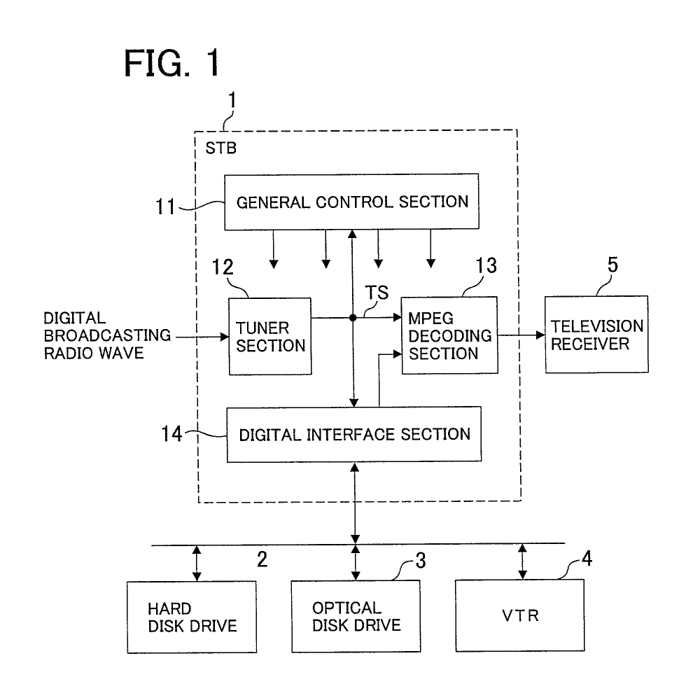

Referring first to FIG. 1, there is shown a data decoding recording apparatus to which the present invention is applied. The data decoding recording apparatus includes a set top box (STB) 1, and a plurality of recording apparatus including a hard disk drive (HDD) 2, an optical disk drive 3 and a video tape recorder (VTR) 4.

The set top box 1 includes a general control section 11 for controlling the entire set top box 1 and the entire recording apparatus 2, 3 and 4, a tuner section 12 for receiving a digital broadcasting radio wave, an MPEG decoding section 13 for decoding MPEG compressed data, and a digital interface section 14 for interfacing with the recording apparatus 2 to 4 and other external apparatus to allow inputting and outputting of data to and from the set top box 1.

The general control section 11 includes a central processing unit (CPU) not shown which receives an output of the tuner section 12, extracts a copy control code from the output of the tuner section 12, discriminates the copy control code and controls recording operations of the recording apparatus 2 to 4 in accordance with a result of the discrimination. The CPU further performs electronic program guide (EPG) processing, data broadcasting processing and so forth.

The tuner section 12 receives and demodulates a digital broadcasting radio wave, performs Viterbi decoding, error correction processing with the Reed-Solomon code and other necessary processing for data obtained by the demodulation and outputs resulting data as a transport stream TS prescribed in the MPEG-2.

The MPEG decoding section 13 receives the transport stream TS outputted from the tuner section 12, decodes image and sound data in the MPEG compressed form and signals the decoded image and sound data to a television receiver 5.

The digital interface section 14 preferably is an interface of the IEEE 1394 system, and receives the transport stream TS outputted from the tuner section 12 and outputs the transport stream TS to the recording apparatus 2 to 4 or some other external apparatus. Further, the digital interface section 14 receives a transport stream from any of the recording apparatus 2 to 4 and some other external apparatus and signals the transport stream to the MPEG decoding section 13.

Of the recording apparatus 2 to 4, the hard disk drive 2 may be formed as a built-in apparatus built in the set top box 1 or alternatively may be connected as an externally provided apparatus through a digital interface although a hard disk drive is very often formed as a built-in apparatus built in an STB. Also the optical disk drive 3 and the VTR 4 may each be formed as a built-in apparatus or alternatively as an externally provided apparatus connected through a digital interface although an optical disk drive or a VTR is very often formed as an externally provided apparatus. In FIG. 1, the recording apparatus 2 to 4 are all shown formed as externally provided apparatus.

A hard disk drive such as the hard disk drive 2 is characterized in that it has a large recording capacity and therefore is advantageous in that it allows endless recording wherein, even if an overflow occurs when continuous recording is performed, recording is possible from the beginning. Accordingly, the hard disk drive is suitable for time shift enjoyment wherein contents of broadcasting programs are recorded without any selection and only a favorite broadcasting program is played back and enjoyed later. On the other hand, the hard disk drive has another characteristic in that a disk serving as a recording medium cannot be removed or exchanged. Therefore, the hard disk drive is disadvantageous in that it cannot store further data and, if an overflow occurs upon recording onto the disk, then recorded data on the disk must be partly erased to record new data.

An optical disk drive such as the optical disk drive 3 has a characteristic in that an optical disk serving as a recording medium can be exchanged and therefore is advantageous in that the order of reproduction of recorded data can be designated and editing involving recording can be realized on the optical disk. Accordingly, although the recording capacity of one optical disk is smaller than that of a hard disk, the recording capacity can be expanded by exchanging the optical disk.

A VTR such as the VTR 4 is advantageous in that the recording capacity of a magnetic tape serving as a recording medium is very large and the magnetic tape can be exchanged. Accordingly, the VTR is suitable to record and preserve contents of broadcasting programs without selecting them. However, the VTR is disadvantageous in that comparatively long time is required for search and editing on the magnetic tape.

According to the present invention, taking such characteristics of the recording apparatus as described above into consideration, a recording apparatus to be used is selectively determined based on a result of discrimination of an extracted copy control code so that contents are recorded onto the selected recording apparatus. In particular, contents whose copy control code is “00”, that is, copy-free contents, are recorded onto a hard disk drive, and then, time shift enjoyment of the contents is performed. Then, the contents are erased immediately, or when necessary, the contents are copied onto an optical disk or a magnetic tape and edited and preserved on the optical disk or magnetic tape.

On the other hand, contents whose copy control code is “10”, that is, contents which can be copied only once, are recorded simultaneously by both of an optical disk drive and a VTR or by at least one of an optical disk drive and a VTR while they are prevented from being recorded by a hard disk drive. Consequently, the contents can be preserved as an optical disk and/or a magnetic disk.

Now, operation of the data decoding recording apparatus is described.

A digital broadcasting radio wave is subject to demodulation, Viterbi decoding and error correction processing with the Reed-Solomon code by the tuner section 12 and is outputted as a transport stream prescribed in the MPEG-2 from the tuner section 12. The general control section 11 receives the transport stream of the contents from the tuner section 12 and, if an instruction to copy contents is received from the user, extracts a copy control code from the received transport stream and analyzes the copy control code. Then, the general control section 11 controls the recording apparatus connected to the set top box 1 to record the contents in accordance with a result of the analysis of the copy control code.

Here, an example of operation of the general control section 11 where the hard disk drive 2 and the optical disk drive 3 are connected as such recording apparatus to the set top box 1 is described.

When the copy control code is “00” (copy-free), the general control section 11 controls the hard disk drive 2 to record the contents through the digital interface section 14. When the copy control code is “10” (copying is permitted only once), the general control section 11 either controls the optical disk drive 3 to record or controls both of the hard disk drive 2 and the optical disk drive 3 to simultaneously record the contents through the digital interface section 14. It is to be noted that, when contents whose copy control code is “10” (copying is permitted only once) are to be recorded onto a medium, the copy control code of the contents to be recorded is rewritten to “01” or “11” representing inhibition of copying thereby to realize permission of copying only once.

When the contents recorded on the hard disk drive 2 and having the copy control code of “00” are to be time shift enjoyed, the data played back by the hard disk drive 2 are sent through the digital interface section 14 to the MPEG decoding section 13 by which MPEG compressed image and sound data are decoded from the data. The decoded image and sound data are signaled to the television receiver 5. Further, when necessary, the played back data are recorded through the digital interface section 14 by the optical disk drive 3 so that they are copied and preserved onto an optical disk.

When contents inputted with the copy control code of “10” and recorded on a medium of the hard disk drive 2 or the optical disk drive 3 with the copy control code thereof rewritten to “01” or “11” are to be time shift enjoyed, the played back data are sent through the digital interface section 14 to the MPEG decoding section 13, by which MPEG compressed image and sound data are decoded from the data. The decoded image and sound data are signaled to the television receiver 5. The optical disk of the recording medium on which the contents inputted with the copy control code of “10” are recorded is unloaded from the optical disk drive 3 and preserved. On the other hand, the contents recorded on the hard disk drive 2 are erased after the time shift enjoyment. In this manner, when the copy control code is “10”, by recording the data onto the optical disk drive 3 or recording the data onto both of the hard disk drive 2 and the optical disk drive 3 simultaneously, an optical disk on which the contents are recorded can be preserved.

Subsequently, an example of operation of the general control section 11 where the hard disk drive 2 and the VTR 4 are connected as recording apparatus is described.

In this instance, when the copy control code is “00”, the general control section 11 controls the hard disk drive 2 to record the contents through the digital interface section 14. When the copy control code is “10”, the general control section 11 either controls the VTR 4 to record or controls both of the hard disk drive 2 and the VTR 4 to simultaneously record the contents through the digital interface section 14.

When the contents recorded on the hard disk drive 2 and having the copy control code of “00” are to be time shift enjoyed, the data played back by the hard disk drive 2 are sent through the digital interface section 14 to the MPEG decoding section 13, by which MPEG compressed image and sound data are decoded from the data. The decoded image and sound data are signaled to the television receiver 5. Further, when necessary, the played back data are recorded by the VTR 4 through the digital interface section 14 so that they can be recorded onto and preserved as a magnetic tape.

When contents inputted with the copy control code of “10” and recorded on a medium of the hard disk drive 2 or the VTR 4 with the copy control code thereof rewritten to “01” or “11” are to be time shift enjoyed, the played back data are sent through the digital interface section 14 to the MPEG decoding section 13, by which MPEG compressed image and sound data are decoded from the data. The decoded image and sound data are signaled to the television receiver 5. The magnetic tape on which the contents inputted with the copy control code of “10” are recorded is unloaded from the VTR 4 and preserved. On the other hand, the contents recorded on the hard disk drive 2 are erased after the time shift enjoyment. In this manner, when the copy control code is “10”, by recording the data onto the VTR 4 or recording the data onto both of the hard disk drive 2 and the VTR 4 simultaneously, a magnetic tape on which the contents are recorded can be preserved.

Subsequently, an example of operation of the general control section 11 where the optical disk drive 3 and the VTR 4 are connected as recording apparatus is described.

In this instance, since contents recorded by the optical disk drive 3 and the VTR 4 can be preserved as an optical disk or a magnetic tape, when the copy control code is “00” or “10”, the general control section 11 either controls one of the optical disk drive 3 and the VTR 4 to record or controls both of the optical disk drive 3 and the VTR 4 to simultaneously record the contents through the digital interface section 14.

Subsequently, an example of operation of the general control section 11 where the hard disk drive 2, the optical disk drive 3 and the VTR 4 are connected as recording apparatus is described.

In this instance, when the copy control code is “00”, the general control section 11 controls the hard disk drive 2 to record the contents through the digital interface section 14. When the copy control code is “10”, the general control section 11 either controls either one of the optical disk drive 3 and the VTR 4 to record or controls both of the optical disk drive 3 and the VTR 4 or all of the hard disk drive 2, optical disk drive 3 and VTR 4 to simultaneously record the contents through the digital interface section 14.

It is to be noted that, while, in the foregoing description, the general control section 11 has the copy control code extraction and discrimination function and the recording apparatus control function, the functions may be provided for each of the recording apparatus so that recording control may be performed on each of the recording apparatus.

Further, the selection of recording apparatus is not limited to those examples described hereinabove. For example, where a hard disk drive and an optical disk drive are connected, contents whose copy control code is “00” may be recorded by the optical disk drive, bur contents whose copy control code is “10” may be recorded by the hard disk drive. In this manner, apparatus to be used for recording can be selected in any suitable manner.

By the way, contents usually include a portion unnecessary to a user such as, for example, a commercial message (CM) or an interview with a participant in a music program. Contents whose copy control code is “00” can be edited by deleting an unnecessary portion after recorded. However, contents whose copy control code is “10” do not allow editing thereof which involves re-recording after recorded once. Accordingly, there is a problem that such editing as deletion of an unnecessary portion cannot be performed.

Another problem resides in that, where contents which can be copied only once are recorded, even if it is intended to add another music or voice of a narration or the like after the contents are copied, such addition cannot be performed immediately.

As a solution to the former problem, when contents whose copy control code is “10” and which can be copied only once are to be recorded, they are recorded with an unnecessary portion deleted in accordance with a rule determined in advance. In particular, the contents are recorded after CM cutting processing or interview portion cutting processing in a music program is performed for the contents.

In order to delete an unnecessary portion of contents, a function of discriminating contents of a transport stream and deleting an unnecessary portion of the transport stream so that the remaining necessary portion of the transport stream may be recorded is provided for the general control section 11 or for each of the recording apparatus 2, 3 and 4.

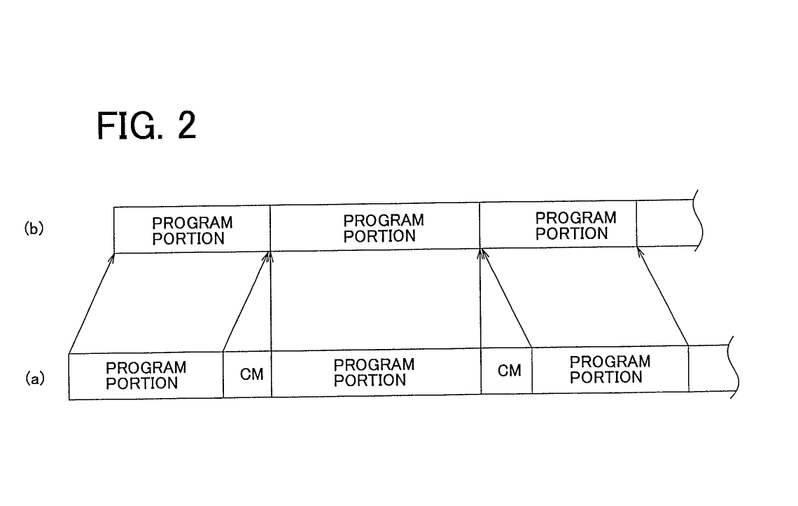

FIG. 2 illustrates an example of recording with a commercial message (CM) as an unnecessary portion deleted.

A transport stream of contents outputted from the tuner section 12 includes program portions and CM portions as seen in FIG. 2(a). When the contents are to be recorded, it is discriminated whether or not each portion of the transport stream is a program portion or a CM portion, and if the portion is discriminated as a program portion, then it is recorded, but if the portion is discriminated as a CM portion, then it is not recorded. Consequently, the transport stream can be recorded as a transport stream from which the CM portions have been removed as seen in FIG. 2(b).

It is to be noted that, in order to discriminate a program portion and a CM portion from each other, for example, a method of detecting a CM identification code and another method of discriminating a monaural sound portion as a program portion and discriminating a stereo sound portion as a CM portion are available. Further, since it is considered that contents whose copy control code is “10” and which can be copied only once do not include a CM portion while copy-free contents whose copy control code is “00” include a CM portion, a further method can be applied wherein only contents whose copy control code is “10” are recorded whereas contents whose copy control code is “00” are not recorded.

In order to solve the latter program described above, when contents whose copy control code is “10” and which can be copied only once are to be recorded, two or more sound streams are secured as sound data recording areas, and received sound data are recorded into a sound data recording area for one of the sound streams while the remaining one or more streams are filled with a particular stuffing bit (for example, “0” bit). Here, since any stream filled with the stuffing bits has no copy control code recorded therein, sound data can be additionally recorded into the stream.

When sound such as another music or narration is to be additionally recorded after contents whose copy control code is “10” are recorded, additional recording is performed for a sound stream for additional recording filled with the stuffing bits.

In order to perform such additional recording of sound, a function of securing a sound steam for additional recording when the copy control code is “10” is provided for the general control section 11. Further, the number of streams to be secured for additional recording of sound may be fixed to one stream or else may be set basically to one stream whereas an additional stream or streams can be designated by the user.

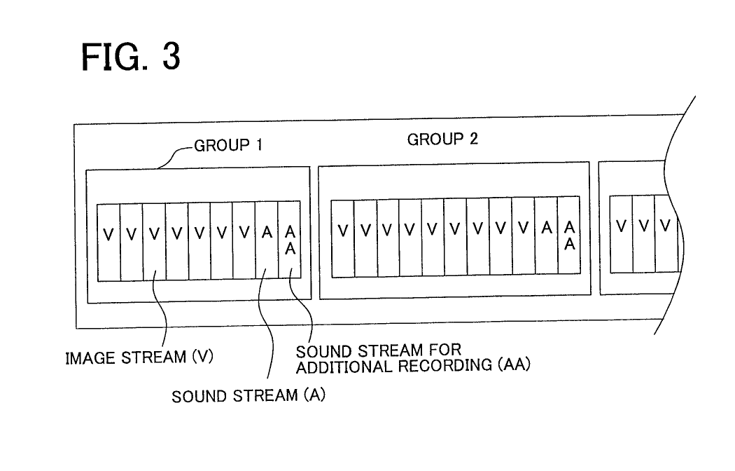

FIG. 3 illustrates an example of image and sound data recorded on a recording medium.

Here, received image and sound data are divided into a group for each fixed interval of time, and in each group, image data are recorded as a plurality of image streams (V) and sound data are recorded as one sound stream (A). Further, a copy control code is recorded for each stream. If contents whose copy control code is “10” (copying is permitted only once) are recorded, then the copy control codes of the video streams (V) and the sound streams (A) recorded on the medium are “01” or “11” (copying is inhibited).

Further, in order to additionally record sound, a sound stream (AA) for additional recording is secured adjacent each sound stream (A). The sound stream (AA) for additional recording is filled with stuffing bits and has no code representative of inhibition of copying recorded therein. Accordingly, another sound can be additionally recorded into the sound stream (AA) for additional recording later.

Generally in a disk drive, if partial erasure of data recorded on the disk and/or recording of data onto the disk are repeated, then such erased regions are discretely distributed on the disk. Thus, when recording of new data onto the disk is performed continuously, the head performs its seeking operation so frequently that, depending upon the capacity of the disk drive, a phenomenon that continuous recording or continuous playback cannot be performed appears. In order to prevent such a phenomenon as just described, a deflag operation of changing the order of arrangement of data on the disk to establish a state wherein continuous recording is possible is performed.

However, an optical disk drive has a problem in that, where contents inputted with the copy control code of “10” (copying is permitted only once) are recorded on a medium, since the contents on the medium have the copy control code rewritten to “01” or “11” (copying is inhibited), a deflag operation which involves copying processing cannot be performed.

Thus, contents whose copy control code is “10” are inhibited from being recorded into a partially erased area but are recorded continuously to the last end of data recorded already on the disk without fail. This can prevent the data from being recorded discretely on the optical disk, and consequently, stable continuous recording and playback can be realized while preventing frequent seeking of the optical head.

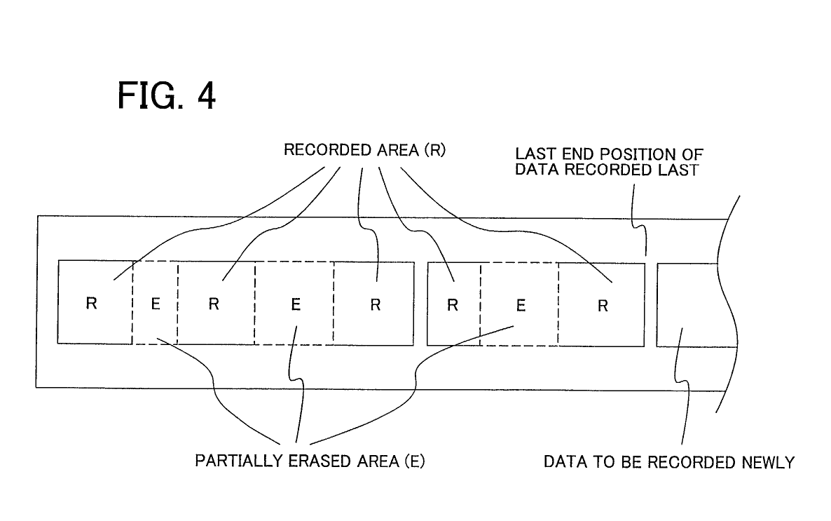

In order to achieve such recording control as just described, when the copy control code extracted and discriminated is “10” (copying is permitted only once), the general control section 11 controls the optical disk drive 3 so that, as shown in FIG. 4, recording into any partially erased area (E) on the optical disk is inhibited but new data are recorded continuously to the last end of a data area (R) recorded already without fail. It is to be noted that, when the copy control code is “00” (copy-free), the general control section 11 permits recording into any partially erased area.

While a preferred embodiment of the present invention has been described using specific terms, such description is for illustrative purposes only, and it is to be understood that changes and variations may be made without departing from the spirit or scope of the following claims.

What is claimed is:

1. A data decoding recording apparatus capable of receiving and decoding a digital broadcast and recording contents of data of the received digital broadcast by a plurality of recording apparatus for different recording media in response to a copy control code included in the received data, comprising:
control means for extracting and analyzing the copy control code from the received data and selecting and controlling one or those of said recording apparatus which should execute a recording operation regarding the received data in response to a result of the analysis of the copy control code.

2. A data decoding recording apparatus as claimed in claim 1, wherein said recording apparatus include a hard disk drive and an optical disk apparatus, and when the copy control code represents a copy-free condition, said control means controls said hard disk drive to record the contents, but when the copy control code represents permission of copying only once, said control means either controls said optical disk drive to record the contents or controls both of said hard disk drive and said optical disk apparatus to record the contents.

3. A data decoding recording apparatus as claimed in claim 1, wherein the recording apparatus include a hard disk drive and a video tape recorder, and when the copy control code represents a copy-free condition, said control means controls said hard disk drive to record the contents, but when the copy control code represents permission of copying only once, said control means either controls said video tape recorder to record the contents or controls both of said hard disk drive and said video tape recorder to record the contents.

4. A data decoding recording apparatus as claimed in claim 1, wherein the recording apparatus include an optical disk apparatus and a video tape recorder, and when the copy control code represents a copy-free condition, said control means controls said video tape recorder to record the contents, but when the copy control code represents permission of copying only once, said control means either controls said optical disk apparatus to record the contents or controls both of said optical disk apparatus and said video tape recorder to record the contents.

5. A data decoding recording apparatus as claimed in claim 1, wherein the recording apparatus include a hard disk drive, an optical disk apparatus and a video tape recorder, and when the copy control code represents a copy-free condition, said control means controls said hard disk drive to record the contents, but when the copy control code represents permission of copying only once, said control means either controls one of said optical disk apparatus and said video tape recorder or both of said optical disk apparatus and said video tape recorder to record the contents or controls all of said hard disk drive, said optical disk apparatus and said video tape recorder to record the contents.

6. A data decoding recording apparatus according to claim 1, wherein, when the copy control code represents permission of copying only once, said control means deletes any unnecessary portion included in the contents in accordance with a rule determined in advance and controls any of said recording apparatus to copy the remaining portion of the contents.

7. A data decoding recording apparatus according to claim 1, wherein said control means controls any of said recording apparatus to record contents whose copy control code represents permission of copying only once and which are considered not to include a commercial message portion but controls any of said recording apparatus to record contents whose copy control code represents a copy-free condition and which are considered to include a commercial message portion.

8. A data decoding recording apparatus according to claim 1, wherein, when the copy control code represents permission of copying only once, said control means secures two or more sound streams as sound data recording areas for the contents in advance and records the received sound data into the sound data recording area for one of the sound streams but fills the remaining one or more streams with a particular stuffing bit so that sound data may be additionally recorded into the stream or streams filled with the stuffing bits.

9. A data decoding recording apparatus according to claim 1, wherein, when the copy control code represents permission of copying only once, said control means inhibits recording into a partially erased area of a recording medium of any of said recording apparatus and causes data to be recorded continuously to the last end of the recorded data without fail.
